(19) United States
(12) Patent Application Publication
(10) Pub. No.: US 2003/0069996 A1
(43) Pub. Date: Apr. 10, 2003

(54) INFRARED TO RADIO FREQUENCY ADAPTER AND METHOD FOR USING THE SAME

(76) Inventor: WILLIAM M. PARROTT, SIMI VALLEY, CA (US)

Correspondence Address: LIBBY HOPE, ESQ., 12400 WILSHIRE BLVD., 7TH FLOOR, LOS ANGELES, CA, 90025-1030, US

(21) Appl. No.: 09/385,315

(22) Filed: Aug. 30, 1999

(51) Int. Cl. G06F 15/16

(52) U.S. Cl. 709/250; 709/249

(57) ABSTRACT

An infrared to radio frequency adapter and method for using the same enables a computing device, such as a notebook computer having an infrared data port, to wirelessly link to a network without the need to install any additional hardware or software into the computing device. The adapter is configured to operate with a plurality of computing devices including desktop and notebook computers, handheld computers, and mobile telephones. By providing instant connectivity between one or more computing devices and a local or wide area network, the adapter provides users with the versatility necessary to provide seamless network integration. Thus, a user can immediately check e-mail or access the Internet simply by directing an IR-enabled computing device at an adapter that is within range of a receiving station the RF data system component of a network.

### BACKGROUND OF THE INVENTION

1. Field of the Invention

The present invention relates generally to wireless networking, and more particularly, to a stand-alone infrared (IR) to radio frequency (RF) adapter that enables a computing device, such as a notebook or other computer, to wirelessly link to a network without the need to install additional hardware or software into the computing device.

2. Description of the Related Art

The popularity of portable computing devices has grown significantly in recent years. Portable computing devices typically include mobile personal computers (PCs), mobile telephones, and handheld computers (e.g., the PalmPilot® series developed by 3Com Corporation). Many portable computing devices offer versatility and convenience for those who wish to work away from the office or from home. However, portable computing devices have only limited access to the resources available to more permanent desktop computers. For example, while at work, users have instant access to e-mail and the Internet as well as network databases that often include document files and other important information. Residential desktop computer users also have the ability to connect to the Internet and typically enjoy data storage capabilities that are not found in portable computing devices.

Many portable users have to physically connect their computing devices to a network in order to gain access to network resources. This physical connection often requires cables and other hardware which make portable computing devices less portable. However, there is at least one wireless solution, generally known as Bluetooth, that attempts to overcome the inconvenience of physically connecting a portable computing device to a network.

The so-called Bluetooth protocol refers to an RF data exchange system that provides short-range radio links between mobile PCs, mobile phones, and other portable computing devices. More specifically, a special interest group (SIG) of manufacturers including Ericsson, Nokia, IBM, Toshiba, and Intel (among others) have developed Bluetooth as a solution to provide short-range wireless connectivity by generating real-time data and voice transmissions between a portable computing device and a network. Connections might be to local area networks or might be to wide area networks, such as the Internet. As a wireless network interface, Bluetooth eliminates the need for a physical connection between portable and stationary computing devices or between two or more portable computing devices. Thus, by placing a Bluetooth-enabled portable computing device within 10 meters of another Bluetooth-enabled device, the two devices can communicate (e.g., transfer data) over an RF communication link. Bluetooth also supports point-to-point and point-to-multipoint connections.

One drawback to Bluetooth, however, is that each computing device must be Bluetooth-enabled. That is, the portable computing device must contain a Bluetooth radio interface device to operate with a Bluetooth system. Bluetooth communications are presently contemplated to be conducted over a carrier frequency of 2.4 GHz, which is a relatively new communications band with little present mass market commercial usage. Hence, configuring a portable computing device to operate with a Bluetooth-enabled device or network requires installation of hardware and software, which can be expensive and result in undesirable computer downtime. Portable computing devices are presently commonly supplied with IR communication ports, which are unable to communicate with a Bluetooth-enabled device or other RF data system. These infrared communications ports are generally low cost and also operate in accordance with industry-standard communication protocol. Because the infrared communications ports are optically based, however, they can only conduct communication over line of sight links. The prevalence of IR data ports, as well as their low cost, compact size and lower noise generation are likely to limit the adoption of Bluetooth-enabled communications. Consequently, a significant number of portable computer users will be unable to connect to the Internet or receive e-mail through an industry-standard RF data communication system. As infrared communications are line of sight only, difficulties in implementing an RF data communication system might undesirably prolong reliance on hardwired local area networks and physical network interface connections.

In view of the foregoing, there is a need for a stand-alone adapter that facilitates communication between portable computing devices and devices or networks with RF data systems.

### SUMMARY OF THE INVENTION

Embodiments consistent with the present invention address the foregoing need with a stand-alone, IR to RF adapter that enables a computing device, such as a notebook computer or other computing device having a built-in infrared communications port, to link to an RF data communication system (e.g., through a wireless network interface). Most preferably this is accomplished without the need to install any additional hardware or software into the computing device, unless there is no infrared communications port available.

An aspect of the invention provides an adapter that connects an infrared data port to a radio frequency data system having an infrared transceiver for sending and receiving information to and from the infrared data port. A radio frequency transceiver sends and receives information to and from the radio frequency data system. A processor communicates with the infrared transceiver and the radio frequency transceiver for converting information received from the infrared transceiver to a radio frequency format for transfer to the radio frequency data system and for converting information received from the radio frequency transceiver to an infrared format for transfer to the infrared data port.

Another aspect of the invention provides a system that wirelessly connects a computing device to a network. An infrared data port connected to the computing device is configured to send and receive information. A radio frequency data system in communication with the network is configured to send and receive information. An adapter is configured to transfer information between the infrared data port and the radio frequency data system. The adapter includes an infrared transceiver for sending and receiving information to and from the infrared data port, a radio frequency transceiver for sending and receiving information to and from the radio frequency data system, and a microprocessor. The microprocessor is in communication with the infrared transceiver and the radio frequency transceiver to convert information received from the infrared transceiver to a radio frequency format for transfer to the radio frequency data system and to convert information received from the radio frequency transceiver to an infrared format for transfer to the infrared data port.

An aspect of the invention provides an adapter for connecting a plurality of computing devices having infrared data ports to a radio frequency data system. The adapter may comprise a plurality of infrared transceivers for sending and receiving information to and from the infrared data ports and a radio frequency transceiver for sending and receiving information to and from the radio frequency data system. The adapter may further comprise processing means in communication with the infrared transceivers and the radio frequency transceiver for converting information received from the infrared transceivers to a radio frequency format for transfer to the radio frequency data system and for converting information received from the radio frequency transceiver to an infrared format for transfer to at least one of the infrared data ports.

The invention may also provide a method for wirelessly connecting a computing device to a network. Information received over an infrared communication link from a remote computing device is converted from an infrared format to a radio frequency communication format and is communicated to the network over a radio frequency link.

Another aspect of the invention provides a method for wirelessly connecting a computing device to a network. Information received over a radio frequency communication link from a network is converted from a radio frequency format to an infrared format and communicated to the computing device over an infrared communication link.

### BRIEF DESCRIPTION OF THE DRAWINGS

The accompanying drawings, which are incorporated in and constitute a part of the specification, illustrate presently preferred embodiments of the invention and, together with the preceding general description and the following detailed description, explain the principles of the invention.

In the drawings:

FIG. 1 is a diagram of a network incorporating an IR to RF adapter consistent with the present invention;

FIG. 2 is a diagram of an IR to RF adapter consistent with the present invention;

FIG. 3 is a diagram of an IR to RF network incorporating a multi-port IR to RF adapter consistent with an alternative embodiment the present invention;

FIG. 4 is a diagram of a multi-port IR to RF adapter consistent with an alternative embodiment of the present invention;

FIG. 5 is a flowchart of a method for converting an IR signal to an RF signal using an IR to RF adapter consistent with the present invention; and

FIG. 6 is a flowchart of a method for converting an RF signal to an IR signal using an IR to RF adapter consistent with the present invention.

### DETAILED DESCRIPTION OF THE INVENTION

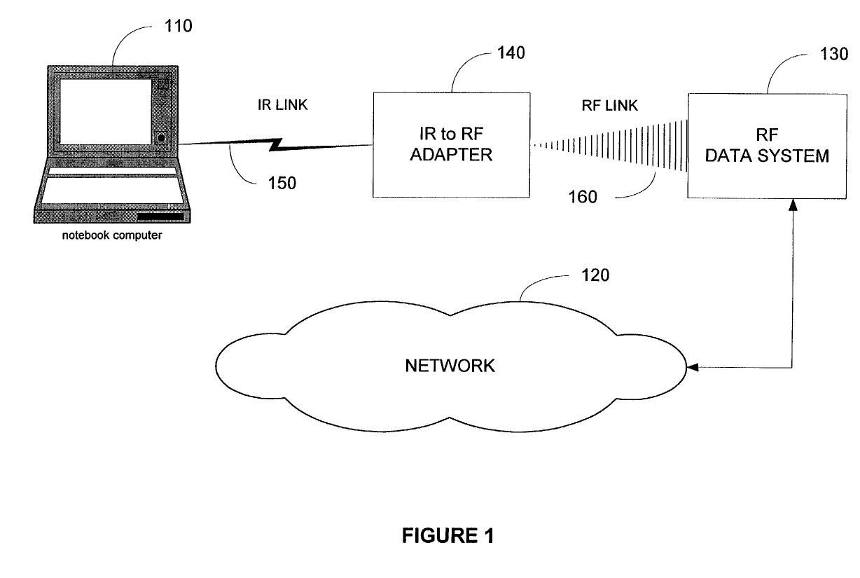

FIG. 1 is a diagram of a network incorporating an IR to RF adapter consistent with the present invention. The network illustrated in FIG. 1 includes a notebook computer 110 in communication with a network 120 (e.g., a wireless local area network) via a RF data system 130 and an IR to RF adapter 140. One skilled in the art will appreciate that the configuration illustrated in FIG. 1 represents merely one example of a network configuration consistent with the present invention. Preferred aspects of the present invention find particular advantage when used with one or more portable computing devices provided with an integral infrared data port.

Notebook computer 110 represents one of many computing devices operable with IR to RF adapter 140. A desktop computer, handheld computer, cellular telephone or other computing device may be substituted for notebook computer 110 or added to network 120. To facilitate operation, notebook computer 110 includes an IR port (not shown) that enables data transfer over an IR communication link 150. Using the IR port in accordance with embodiments consistent with the present invention and described herein, notebook computer 110 may communicate with RF communications network 120 without any physical modifications or additions. That is, installation of dedicated software or hardware to communicate with network 120 is unnecessary. IR to RF adapter 140 includes the necessary technology to instantly connect notebook computer 110 to network 120.

Network 120 is any wireline or wireless network that supports data and/or voice transfer with access to the network provided by radio or RF access ports. For example, network 120 may represent a local area network (LAN) within an office environment. In this environment, notebook computer 110 users may connect to network 120 by using their computer with IR to RF adapter 140 in close proximity to RF data system 130, which receives data and voice information over RF communication link 160 and communicates the data and voice information to network 120. Network 120 may also be a wide area network (WAN), such as a personal communication system (PCS) network, that supports connectivity via RF data system 130.

RF data system 130 is a network interface that facilitates communication between IR to RF adapter 140 and network 120. One example of RF data system 130 is the Bluetooth system, which includes radio components (not shown) which operate in the 2.4 GHz frequency band for data rates of 1 and 2 Mbps. Since the Bluetooth system incorporates what will be established as an industry standard protocol, embodiments consistent with the present invention are most preferably configured to operate with the Bluetooth system. However, one skilled in the art will appreciate that the inventions described herein may be configured to operate with any RF data system to facilitate wireless network connectivity.

IR to RF adapter 140 converts data and voice information between IR and RF formats for a seamless transfer of information between notebook computer 110 and network 120. More specifically, IR to RF adapter 140 receives, for example, information over an IR communication link, converts the information from an IR format to an RF format compatible with RF data system 130 (e.g., in the 2.4 GHz frequency band), and transfers the information to network 120 via RF data system 130. IR to RF adapter 140 may either be physically adjacent to the IR port of notebook computer 110 or be distanced from the IR port of notebook computer 110. For example, a user may position IR to RF adapter 140 at a one meter distance from notebook computer 110 and receive data and voice information over IR communication link 150.

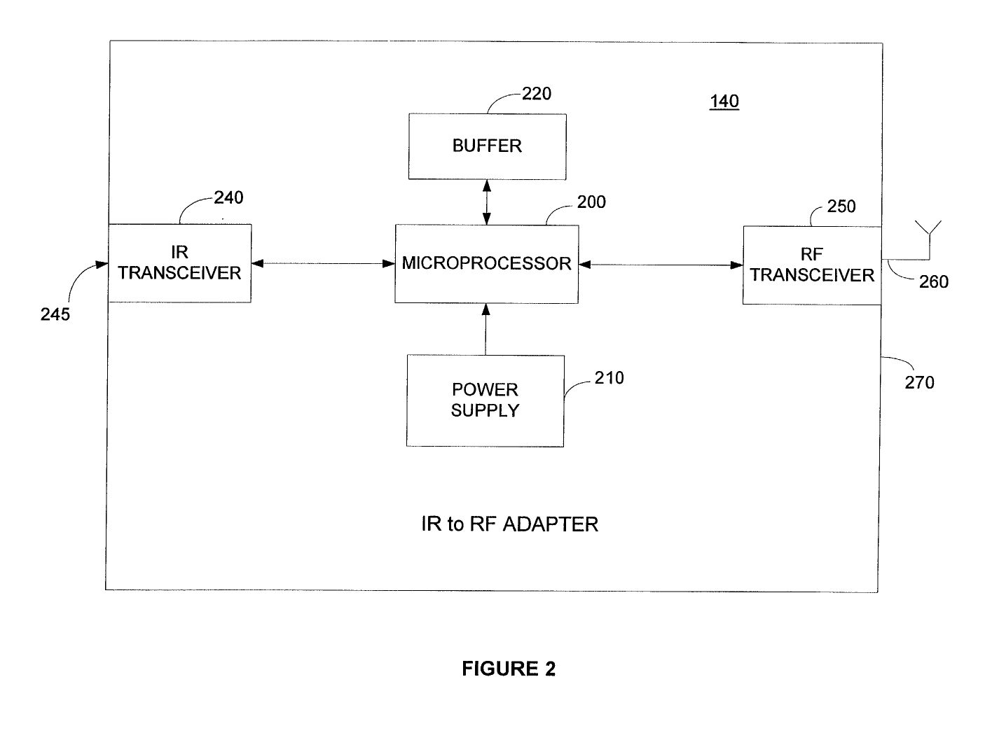

FIG. 2 is a diagram of IR to RF adapter 140 consistent with the present invention. IR to RF adapter 140 includes a microprocessor 200, a power supply 210, a buffer 220, an IR transceiver 240, a RF transceiver 250, and a housing 270. Additional components may be incorporated into IR to RF adapter 140, which are not illustrated in FIG. 2. For example, IR to RF adapter 140 may include additional memory components and dedicated hardware and software components to enable communication between specified devices (e.g., a secure network of encrypted communication devices).

Microprocessor 200 is preferably a high-speed processor powered by power supply 210 and programmed to seamlessly convert data and voice information between IR and RF formats. The conversion involves changing the communication protocol from an IR format to a RF format compatible with RF data system 130 (FIG. 1). For data or voice transmission from RF data system 130, microprocessor 200 converts the signal from a RF format to an IR format before communicating the signal to the targeted computing device. During the conversion between IR and RF formats, data and voice information may be temporarily stored in buffer 220. IR to RF adapter 140 can convert data and voice signals from an IR to a RF format and convert data and voice signals from a RF to an IR format. Microprocessor 200 is programmed to convert data or voice signals into a format compatible with one or more specific types of RF data systems 130. Consequently, using IR to RF adapter 140, a user can establish a wireless connection with any device or network RF data system configured to operate with microprocessor 200.

IR transceiver 240 generates and receives IR signals. IR transceiver 240 may include a commercially available transceiver that generates and receives IR signals consistent with the present invention as described herein. For example, IR transceiver 240 may include a driver circuit that can produce an IR signal for sending data and voice information to notebook computer 110. Furthermore, IR transceiver 240 may include a receiver circuit that senses data and voice carrying infrared signals directed towards IR to RF adapter 140. IR transceiver 240 communicates incoming IR signals to microprocessor 200 for processing and generates outgoing IR signals with information received from microprocessor 200.

RF transceiver 250 communicates with microprocessor 200 to generate and receive RF signals from RF data system 130. RF transceiver 250 may include a commercially available transceiver that performs the generating and receiving functions of IR to RF adapter 140 as described herein. To facilitate transfer of data and voice information between IR to RF adapter 140 and RF data system 130, RF transceiver 250 includes an antenna 260. Although illustrated as external, antenna 260 may be integrated into IR to RF adapter 140 so as not to be visible by the user.

The components of IR to RF adapter 140 are enclosed in a housing 270. A port 245 extends through housing 270 and is aligned with IR transceiver 240 to facilitate sending and receiving IR signals from notebook computer 110. Housing 270 is preferably made from a durable material, such as plastic, to minimize damage to the internal components from repeated use. One skilled in the art will appreciate that IR to RF adapter 140 may also be configured in a variety of shapes and sizes and may include multiple, interchangeable parts instead of the unibody design illustrated in FIG. 2.

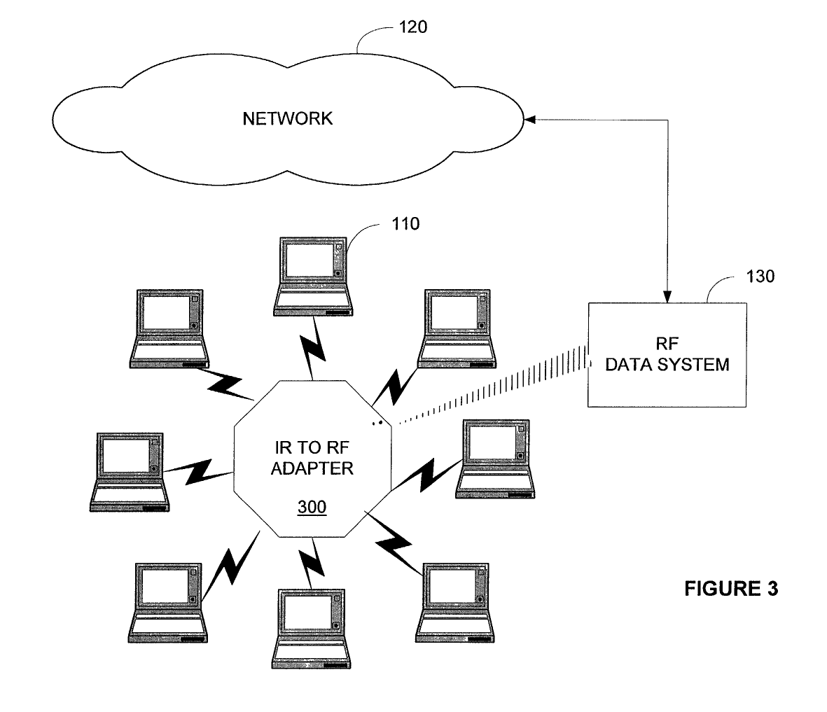

In an alternative embodiment, an IR to RF adapter consistent with the present invention may include multiple IR input ports to connect a plurality of computing devices to network 120 via RF data system 130. FIG. 3 is a diagram of an IR to RF network incorporating a multi-port IR to RF adapter 300 consistent with the present invention. Although multi-port IR to RF adapter 300 provides similar functionality as IR to RF adapter 140, it may receive two or more simultaneous IR input signals and send two or more simultaneous IR output signals. FIG. 3 illustrates multi-port IR to RF adapter 300 as an octagonal-shaped device with eight spaced-apart ports. However, multi-port IR to RF adapter 300 may have any configuration (e.g., a rectangular shape) and any number of IR ports (e.g., 5).

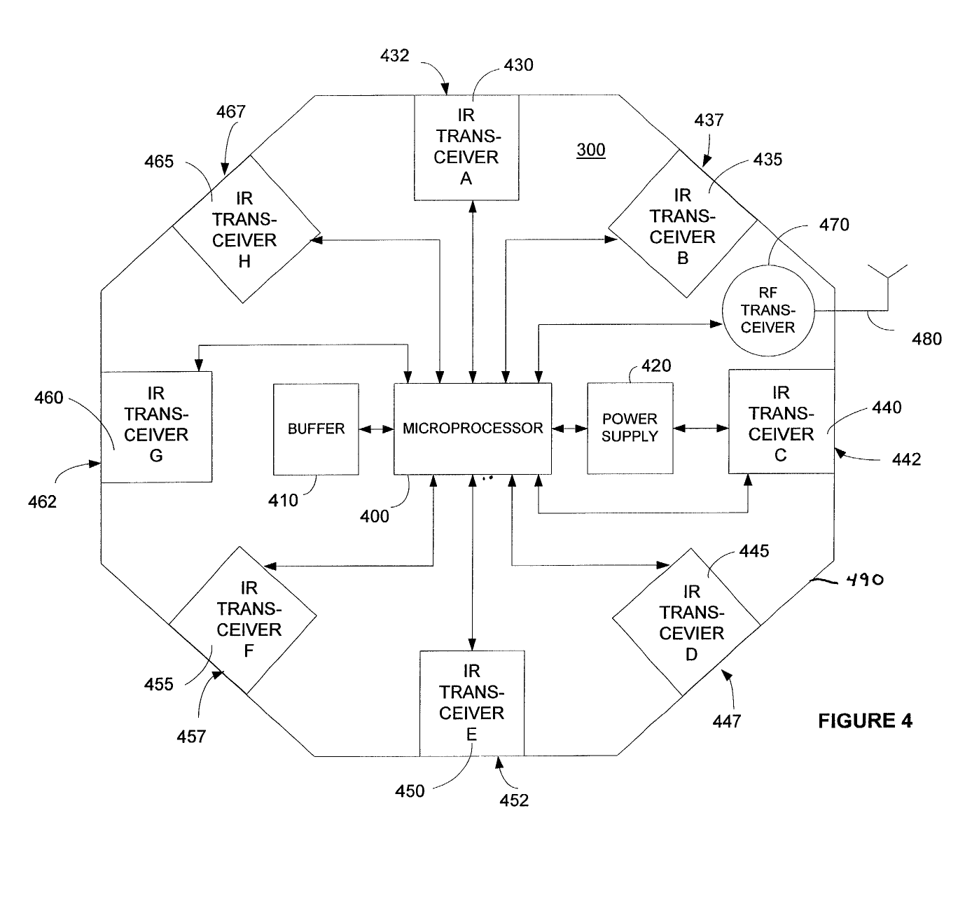

FIG. 4 is a diagram of multi-port IR to RF adapter 300 consistent with the present invention. This adapter includes microprocessor 400, buffer 410, power supply 420, IR transceiver A 430, IR transceiver B, 435, IR transceiver C 440, IR transceiver D 445, IR transceiver E 450, IR transceiver F 455, IR transceiver G 460, IR transceiver H 465, RF transceiver 470, and housing 490. One skilled in the art will appreciate that additional components may be incorporated into multi-port IR to RF adapter 300, which are not illustrated in FIG. 4. For example, multi-port IR to RF adapter 300 may include additional memory components and dedicated hardware and software components to enable communication between specified devices.

Microprocessor 400 is preferably a high-speed processor powered by power supply 420 and programmed to seamlessly convert data and voice information between IR and RF formats. The conversion involves changing the communication protocol from an IR format to a RF format compatible with RF data system 130. Microprocessor 400 controls incoming data from each computing device accessing network 120, whether serially or simultaneously communicated to multi-port IR to RF adapter 300. For data or voice information transmitted from RF data system 130, microprocessor 400 converts the signal from an RF format to an IR format before communicating the data signal to one or more of the targeted computing devices. During the conversion between IR and RF formats, data may be temporarily stored in buffer 410. Multi-port IR to RF adapter 300 is configured to both convert data and voice signals from an IR to a RF format and convert data and voice signals from a RF to an IR format. Microprocessor 400 is programmed to convert a data or voice signal into a format compatible with one or more specific types of RF data systems 130. Consequently, using multi-port IR to RF adapter 300, multiple users can establish a wireless connection with any network RF data system configured to operate with microprocessor 400.

IR transceivers A-H 430-465 communicate with microprocessor 400 to generate and receive IR signals to and from a plurality of computing devices operating within a predetermined proximity from multi-port adapter 300. IR transceivers A-H 430-465 may include commercially available transceivers that perform the generating and receiving functions of multi-port IR to RF adapter 300 as described herein. For example, each IR transceiver in multi-port IR to RF adapter 300 may include a driver circuit and a receiver circuit for sending and receiving data, respectively, over an IR communication link.

RF transceiver 470 communicates with microprocessor 400 to generate and receive RF signals from RF data system 130. RF transceiver 470 may include a commercially available transceiver that performs the generating and receiving functions of multi-port IR to RF adapter 300 as described herein. To facilitate transfer of data and voice information between multi-port IR to RF adapter 300 and RF data system 130, RF transceiver 470 includes an antenna 480. Although illustrated as external, antenna 480 may be integrated into multi-port IR to RF adapter 300 so as not to be visible by the user. Multi-port IR to RF adapter 300 may include additional RF transceivers 470 to accommodate increased data flow generated by multiple computing devices connected to the network.

The components of multi-port IR to RF adapter 300 are enclosed in a housing 490. Extending through housing 490 are ports 432, 437, 442, 447, 452, 457, 462, and 467 aligned with IR transceivers A-H to facilitate sending and receiving IR signals from one or more of the computing devices connected thereto. Housing 490 is preferably made from a durable material, such a plastic, to minimize damage to the internal components due to repeated use.

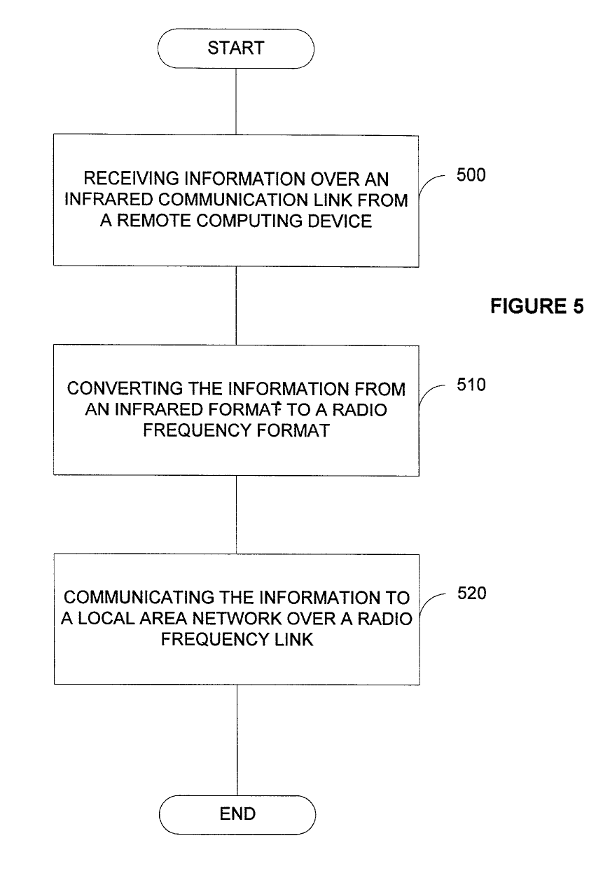

FIG. 5 is a flowchart of a method for converting an IR signal to an RF signal using an IR to RF adapter consistent with the present invention. The method begins with the IR to RF adapter receiving data and/or voice information from a remote computing device over an IR communication link (step 500). The IR to RF adapter converts the information from an IR format to a RF format before transferring the information to an external network (step 510). Once in a RF format, the IR to RF adapter communicates the information to a local area network over a RF link (step 520). This method permits a computing device to send information to a network, such as an e-mail or an audio-visual file.

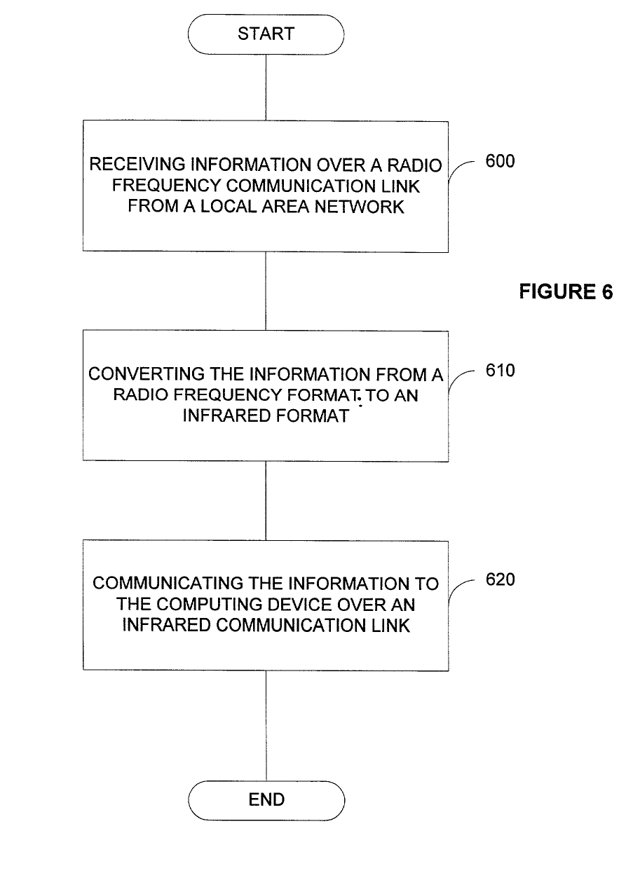

FIG. 6 is a flowchart of a method for converting an RF signal to an IR signal using an IR to RF adapter consistent with the present invention. The method begins with the IR to RF adapter receiving data and/or voice information from a local area network over an RF communication link (step 600). The IR to RF adapter converts the information from an RF format to an IR format before transferring the information to an external computing device (step 610). Once in an IR format, the IR to RF adapter communicates the information to one or more computing devices over an IR link (step 620). This method permits a computing device to receive information from a network, such as a webpage or a document.

Embodiments consistent with the present invention provide a stand-alone IR to RF adapter that enables a computing device, such as a notebook computer, to instantly link to an RF data system (e.g., Bluetooth) without the need to install any additional hardware or software into the computing device. The adapter is configured to operate with a plurality of computing devices including desktop and notebook computers, handheld computers, and mobile telephones. By providing instant connectivity between one or more computing devices and a local area or wide area network, the adapter consistent with the present invention provides users with the versatility necessary to provide seamless network integration. Thus, a user can immediately check e-mail or access the Internet simply by connecting or placing their IR-enabled computing device to or near an adapter that is within range of the RF data system component of a network.

While only some embodiments and methods consistent with the present invention have been described, those skilled in the art will understand that various changes and modifications may be made to these embodiments, and equivalents may be substituted for elements in these embodiments, without departing from the true scope of the invention.

In addition, many modifications may be made to adapt a particular element, technique or implementation to the teachings of the present invention without departing from the central scope of the invention. Therefore, this invention should not be limited to the particular embodiments and methods disclosed herein, but should include all embodiments falling within the scope of the appended claims.

I claim:

1. An adapter for connecting an infrared data port to a radio frequency data system, comprising:
an infrared transceiver for sending and receiving information to and from the infrared data port;
a radio frequency transceiver for sending and receiving information to and from the radio frequency data system; and
a processor in communication with the infrared transceiver and the radio frequency transceiver for converting information received from the infrared transceiver to a radio frequency format for transfer to the radio frequency data system and for converting information received from the radio frequency transceiver to an infrared format for transfer to the infrared data port.

2. The adapter of claim 1, further comprising a buffer for temporary information storage.

3. The adapter of claim 1, further comprising a power supply in communication with the processor.

4. The adapter of claim 1, wherein the infrared transceiver includes a driver circuit for sending information to the infrared data port.

5. The adapter of claim 1, wherein the infrared transceiver includes a receiving circuit for receiving information from the infrared data port.

6. The adapter of claim 1, further comprising a housing.

7. A system for wirelessly connecting a computing device to a network, comprising:
a computing device;
an infrared data port connected to the computing device, the infrared port configured to send and receive information;
radio frequency data system in communication with the network and configured to send and receive information; and
an adapter configured to transfer information between the infrared data port and the radio frequency data system, the adapter including:
an infrared transceiver for sending and receiving information to and from the infrared data port;
a radio frequency transceiver for sending and receiving information to and from the radio frequency data system; and
a microprocessor in communication with the infrared transceiver and the radio frequency transceiver for converting information received from the infrared transceiver to a radio frequency format for transfer to the radio frequency data system and for converting information received from the radio frequency transceiver to an infrared format for transfer to the infrared data port.

8. The system of claim 7, wherein the computing device is a portable computer.

9. The system of claim 7, wherein the adapter physically connects to the computing device.

10. The system of claim 7, wherein the adapter is a stand-alone unit that communicates with the computing device over an infrared communication link.

11. The system of claim 7, wherein the adapter further comprises a buffer providing temporary information storage.

12. The system of claim 7, wherein the adapter further comprises a power supply in communication with the microprocessor.

13. The system of claim 7, wherein the infrared transceiver includes a driver circuit for sending information to the infrared data port.

14. The system of claim 7, wherein the infrared transceiver includes a receiving circuit for receiving information from the infrared data port.

15. An adapter for connecting a plurality of computing devices having infrared data ports to a radio frequency data system, comprising:
a plurality of infrared transceivers for sending and receiving information to and from the infrared data ports;
a radio frequency transceiver for sending and receiving information to and from the radio frequency data system; and
processing means in communication with the plurality of infrared transceivers and the radio frequency transceiver for converting information received from the plurality of infrared transceivers to a radio frequency format for transfer to the radio frequency data system and for converting information received from the radio frequency transceiver to an infrared format for transfer to at least one of the infrared data ports.

16. A method for wirelessly connecting a computing device to a network, comprising:
receiving information over an infrared communication link from a remote computing device;
converting the information from an infrared format to a radio frequency format; and
communicating the information to the network over a radio frequency link.

17. A method for wirelessly connecting a computing device to a network, comprising:
receiving information over a radio frequency communication link from a local area network;
converting the information from a radio frequency format to an infrared signal; and
communicating the information to the computing device over an infrared communication link.
